(19) United States
(12) Patent Application Publication
(10) Pub. No.: US 2006/0268978 A1
(43) Pub. Date: Nov. 30, 2006

(54) Synchronized control scheme in a parallel multi-client two-way handshake system

(76) Inventor: Genkun Jason Yang, Sarasota, CA (US)

Correspondence Address: MCANDREWS HELD & MALLOY, LTD, 500 WEST MADISON STREET, SUITE 3400, CHICAGO, IL, 60661, US

(21) Appl. No.: 11/140,824

(22) Filed: May 31, 2005

(51) Int. Cl. H04N 11/04; H04N 11/02; H04N 7/12; H04B 1/66

(52) U.S. Cl. 375/240.01

(57) ABSTRACT

A synchronized control scheme in a parallel multi-client two-way handshake system is provided and may comprise processing pixels by a plurality of data processing units using at least one shared buffer. The pixels may be communicated to the plurality of data processing units using a centralized and synchronized flow control mechanism. Pixel accept signals may be utilized to communicate the pixels from the shared buffer to the data processing unit, and each pixel accept signal may correspond to a pixel. The pixel accept signal may be generated based on an accept signal from a subsequent pipeline stage to a present pipeline stage in the shared buffer. A generated control signal from the shared buffer to the data processing unit may be used for centralized and synchronized data flow control. A delay may be generated that delays generation of the control signal to handle boundary conditions during processing.

### CROSS-REFERENCE TO RELATED APPLICATIONS/INCORPORATION BY REFERENCE

This application makes reference to:
U.S. patent application Ser. No. 11/083,597 filed Mar. 18, 2005;
U.S. patent application Ser. No. 11/087,491 filed Mar. 22, 2005;
U.S. patent application Ser. No. 11/090,642 filed Mar. 25, 2005;
U.S. patent application Ser. No. 11/089,788 filed Mar. 25, 2005; and
U.S. patent application Ser. No. ______ (Attorney Docket No. 16628US01) filed May 31, 2005.

The above stated applications are hereby incorporated herein by reference in their entirety.

### FIELD OF THE INVENTION

Certain embodiments of the invention relate to accessing data. More specifically, certain embodiments of the invention relate to a synchronized control scheme in a parallel multi-client two-way handshake system.

### BACKGROUND OF THE INVENTION

Advances in compression techniques for audio-visual information have resulted in cost effective and widespread recording, storage, and/or transfer of movies, video, and/or music content over a wide range of media. The Moving Picture Experts Group (MPEG) family of standards is among the most commonly used digital compressed formats. A major advantage of MPEG compared to other video and audio coding formats is that MPEG-generated files tend to be much smaller for the same quality. This is because MPEG uses sophisticated compression techniques. However, MPEG compression may be lossy and, in some instances, it may distort the video content. In this regard, the more the video is compressed, that is, the higher the compression ratio, the less the reconstructed video retains the original information. Some examples of MPEG video distortion are loss of textures, details, and/or edges. MPEG compression may also result in ringing on sharper edges and/or discontinuities on block edges. Because MPEG compression techniques are based on defining blocks of video image samples for processing, MPEG compression may also result in visible “macroblocking” that may result due to bit errors. In MPEG, a macroblock is an area covered by a 16×16 array of luma samples in a video image. Luma may refer to a component of the video image that represents brightness. Moreover, noise due to quantization operations, as well as aliasing and/or temporal effects may all result from the use of MPEG compression operations.

When MPEG video compression results in loss of detail in the video image it is said to “blur” the video image. In this regard, operations that are utilized to reduce compression-based blur are generally called image enhancement operations. When MPEG video compression results in added distortion on the video image it is said to produce “artifacts” on the video image. For example, the term “mosquito noise” may refer to MPEG artifacts that may be caused by the quantization of high spatial frequency components in the image. In another example, the term “block noise” may refer to MPEG artifacts that may be caused by the quantization of low spatial frequency information in the image. Block noise may appear as edges on 8×8 blocks and may give the appearance of a mosaic or tiling pattern on the video image.

There may be some systems that attempt to remove video noise. However, the systems may comprise a data buffer for each of the clients that may be processing the video data. The redundancy of the video buffers may be expensive in terms of chip layout area and power consumed. The various clients may produce processed video data that may be used by other clients and/or combined to create a single output. In order to blend the video data, all of the various video data must be synchronized. Decentralized synchronization may be complex and require much coordination. As the video processing systems get larger, the problems related with chip layout area, power required, and synchronization of the various video streams may be exacerbated.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for a synchronized control scheme in a parallel multi-client two-way handshake system, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary top-level partitioning of a digital noise reduction block.

FIG. 2 is a block diagram illustrating a possible first configuration for a portion of a digital noise reduction block.

FIG. 3 is a block diagram illustrating a possible second configuration for a portion of a digital noise reduction block.

FIG. 4 is a block diagram illustrating an exemplary configuration in use for a portion of a digital noise reduction block with shared data buffer and synchronized control, in accordance with an embodiment of the invention.

FIG. 5 is a block diagram illustrating an exemplary multi-client mode usage model of a pixel buffer in a video noise reduction application, in accordance with an embodiment of the invention.

FIG. 6 is a block diagram illustrating an exemplary centralized reference control with common data buffer, in accordance with an embodiment of the invention.

FIG. 7 is a block diagram illustrating an exemplary data path for client 3 in FIG. 5, in accordance with an embodiment of the invention.

FIG. 8 is a block diagram illustrating an exemplary repeat data control for luma pixel L5 in FIG. 5, in accordance with an embodiment of the invention.

FIG. 9 illustrates an example flow diagram implementing a synchronized control scheme in parallel two-way handshaking system, in accordance with an embodiment of the invention.

### DETAILED DESCRIPTION OF THE INVENTION

Certain embodiments of the invention may be found in a method and system for a synchronized control scheme in a parallel multi-client two-way handshake system. Various aspects of the invention may be utilized for processing video data and may comprise processing pixels by a plurality of data processing units using at least one shared buffer. The pixels may be communicated to the plurality of data processing units using a centralized and synchronized flow control mechanism. Pixel accept signals may be utilized to communicate the pixels from the shared buffer to the data processing unit without using a ready signal. Each pixel accept signal may correspond to a pixel. The pixel accept signal may be generated based on an accept signal from a subsequent pipeline stage in the shared buffer to a present pipeline stage in the shared buffer. A generated control signal from the shared buffer to the data processing unit may be used for centralized and synchronized data flow control. A delay may be generated that delays generation of the control signal to handle boundary conditions during processing.

The processed output pixels generated from the data processing units may be blended. The flow of the pixels may be pipelined by a plurality of pipeline stages within the shared buffer. An accept signal may be communicated from a subsequent pipeline stage to a present pipeline stage and a ready signal may be communicated from a present pipeline stage to a subsequent pipeline stage for the pipelining.

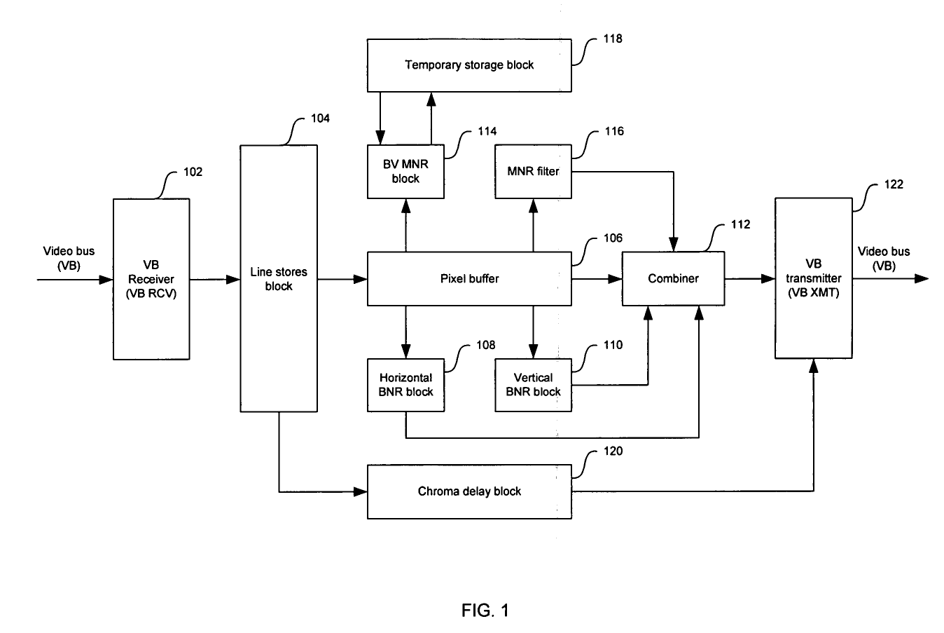

FIG. 1 is a block diagram of an exemplary top-level partitioning of a digital noise reduction block. Referring to FIG. 1, the digital noise reduction block may comprise a video bus receiver (VB RCV) 102, a line stores block 104, a pixel buffer 106, a combiner 112, a horizontal block noise reduction (BNR) block 108, a vertical BNR block 110, a block variance (BV) mosquito noise reduction (MNR) block 114, an MNR filter 116, a temporary storage block 118, and a chroma delay block 120, and a VB transmitter (VB XMT) 122.

The VB RCV 102 may comprise suitable logic, circuitry, and/or code that may be adapted to receive MPEG-coded images in a format that is in accordance with the bus protocol supported by the video bus (VB). The VB RCV 102 may also be adapted to convert the received MPEG-coded video images into a different format for transfer to the line stores block 104. The line stores block 104 may comprise suitable logic, circuitry, and/or code that may be adapted to convert raster-scanned luma data from a current MPEG-coded video image into parallel lines of luma data. The line stores block 104 may be adapted to operate in a high definition (HD) mode or in a standard definition (SD) mode. Moreover, the line stores block 104 may also be adapted to convert and delay-match the raster-scanned chroma information into a single parallel line. The pixel buffer 106 may comprise suitable logic, circuitry, and/or code that may be adapted to store luma information corresponding to a plurality of pixels from the parallel lines of luma data generated by the line stores block 104. For example, the pixel buffer 106 may be implemented as a shift register. The pixel buffer 106 may be common to the MNR block 114, the MNR filter 116, the horizontal BNR block 108, and the vertical BNR block 110 to reduce, for example, chip layout area.

The BV MNR block 114 may comprise suitable logic, circuitry, and/or code that may be adapted to determine a block variance parameter for image blocks of the current video image. The BV MNR block 114 may utilize luma information from the pixel buffer 106 and/or other processing parameters. The temporary storage block 118 may comprise suitable logic, circuitry, and/or code that may be adapted to store temporary values determined by the BV MNR block 114. The MNR filter 116 may comprise suitable logic, circuitry, and/or code that may be adapted to determined a local variance parameter based on a portion of the image block being processed and to filter the portion of the image block being processed in accordance with the local variance parameter. The MNR filter 116 may also be adapted to determine a MNR difference parameter that may be utilized to reduce mosquito noise artifacts.

The HBNR block 108 may comprise suitable logic, circuitry, and/or code that may be adapted to determine a horizontal block noise reduction difference parameter for a current horizontal edge. The VBNR block 110 may comprise suitable logic, circuitry, and/or code that may be adapted to determine a vertical block noise reduction difference parameter for a current vertical edge.

The combiner 112 may comprise suitable logic, circuitry, and/or code that may be adapted to combine the original luma value of an image block pixel from the pixel buffer 106 with a luma value that results from the filtering operation performed by the MNR filter 116. The chroma delay 120 may comprise suitable logic, circuitry, and/or code that may be adapted to delay the transfer of chroma pixel information in the chroma data line to the VB XMT 122 to substantially match the time at which the luma data generated by the combiner 112 is transferred to the VB XMT 122. The VB XMT 122 may comprise suitable logic, circuitry, and/or code that may be adapted to assemble noise-reduced MPEG-coded video images into a format that is in accordance with the bus protocol supported by the VB.

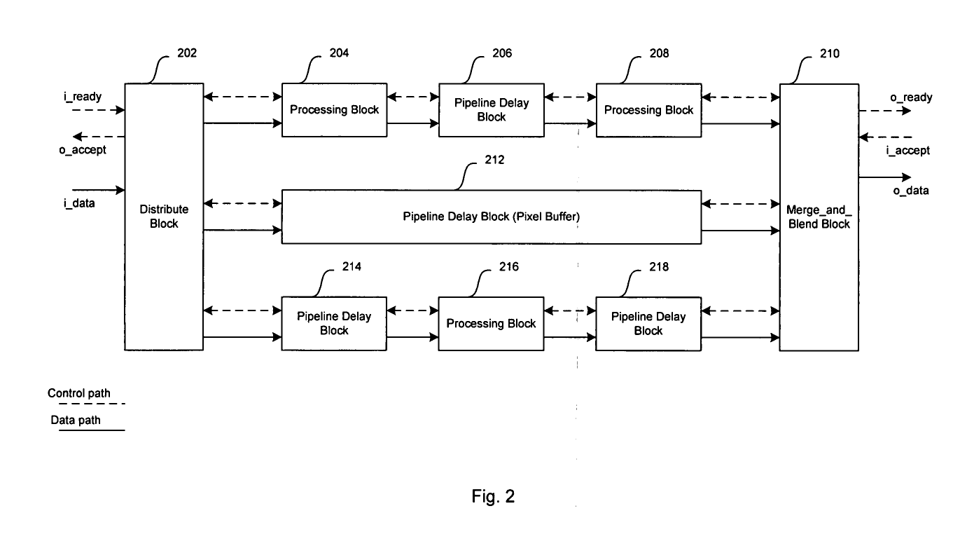

FIG. 2 is a block diagram illustrating a possible first configuration in use for a portion of a digital noise reduction block. Referring to FIG. 2, there is shown a distribute block 202, processing blocks 204, 208, and 216, pipeline delay blocks 206, 212, 214 and 218, and a merge-and-blend block 210. The distribute block 202 may comprise suitable logic, circuitry, and/or code that may be adapted to receive video data and distribute the received video data in a synchronous manner. The distribute block 202 may comprise suitable logic, circuitry, and/or code that may be adapted to communicate received video data to at least one other bock utilizing the ready and accept handshaking signals. The processing blocks 204, 208, and 216 may comprise suitable logic, circuitry, and/or code that may be adapted to process video data, and output the processed video data with appropriate delay in a synchronous manner. The processing block 204, 208, or 216 may be, for example, similar to the BV MNR block 114, the horizontal BNR block 108, or the vertical BNR block 110 (FIG. 1).

The pipeline delay blocks 206, 212, 214 and 218 may comprise suitable logic, circuitry, and/or code that may be adapted to synchronously delay video data in order that the various video data may be correctly aligned with each other. The pipeline delay blocks 206, 212, 214 and 218 may be similar to the pixel buffer 106 or the chroma delay block 120 (FIG. 1). The merge-and-blend block 210 may comprise suitable logic, circuitry, and/or code that may be adapted to synchronize ready and accept handshake signals from three or more video handling blocks, and receive various inputs of video data and combine the plurality of streams of received video data into one stream of video data. In this respect, the merge-and-blend block 210 may be similar to the combiner 112 and/or VB transmitter 122 (FIG. 1).

There is also shown the various two-way handshake signals between the various blocks that may indicate whether the transmitting block is ready to transmit new data and whether the receiving block is ready to receive the new data. The handshaking may be referred to as ready-accept handshaking. The i_ready ready signal and the i_data data signal may be communicated by a video handling block, for example, the VB receiver 102 (FIG. 1), to the distribute block 202. The o_accept accept signal may be communicated by the distribute block 202 to the, for example, the VB receiver 102. The o_ready ready signal and the o_data data signal may be communicated by the merge_and_blend block 210 to a video handling block, for example, the VB transmitter 122. The i_accept accept signal may be communicated to the merge_and_blend block 210 by the, for example, the VB transmitter 122.

For example, the distribute block 202 may assert a ready signal to the processing block 204 when it has data that can be transmitted to the processing block 204. The processing block 204 may have an accept signal deasserted until it is ready to process the new data. The processing block 204 may then assert the accept signal to the distribute block 202 when it has accepted the new data. When the distribute block 202 receives the asserted accept signal from the processing block 204, it may keep the ready signal asserted if it has new data to send. Otherwise, it may deassert the ready signal until it has new data to send to the processing block 204. In this manner, by asserting and deasserting the ready signal and the accept signal, the distribute block 202 may communicate data to the processing block 204.

This illustration may indicate parallel processing of video data where the video data is processed in a plurality of video paths and the three video paths are combined at the end of processing of all three video paths. Video data may be received by the distribute block 202, and the distribute block 202 may communicate the video data to be processed to the three video paths. A first video path may comprise process blocks 204 and 208, and the pipeline delay block 206. A second video path may comprise the pipeline delay block 212. A third video path may comprise the pipeline delays 214 and 218, and the processing block 216. The processed video data from the three video paths may be communicated to the merge_and_blend block 210, and that block may output a single video signal, for example, the o_data video signal.

Each video path may be synchronized with each other when they are communicated to the merge_and_blend block 210. In this manner, the video data from the plurality of video paths may be merged correctly. The synchronization may be provided by appropriate delays in the processing blocks and in the pipeline delay blocks. However, since the ready-accept handshaking may occur independently between any two blocks, assuring synchronization among the various video paths at the merge_and_blend block may be very complex. Each processing block in a video path may be considered to be a client. The various blocks may operate synchronously by utilizing a pre-determined clock signal or clock signals.

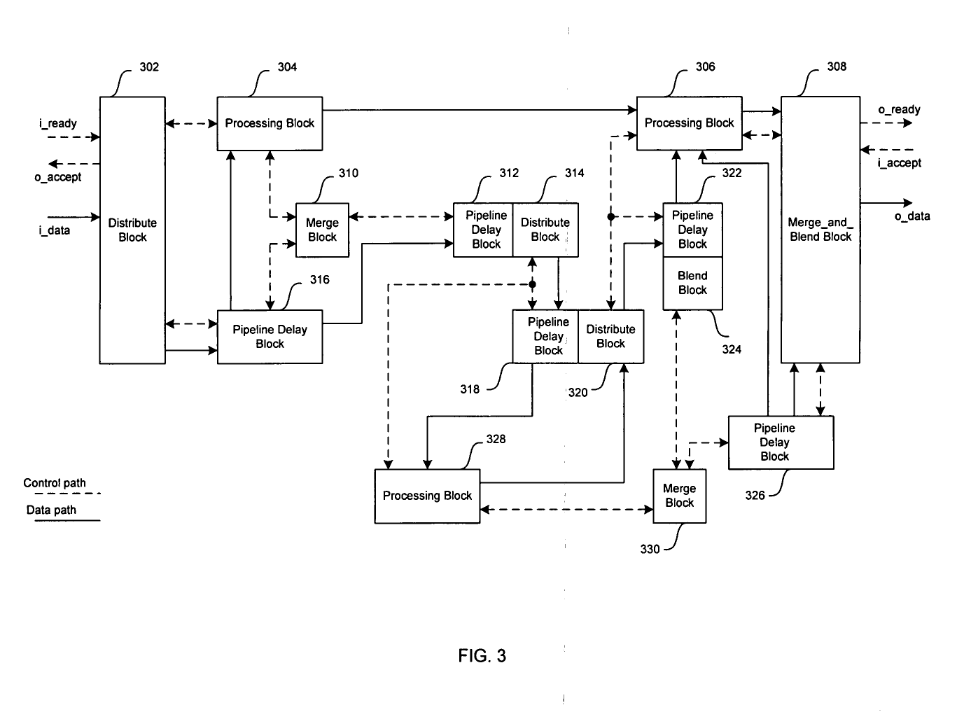

FIG. 3 is a block diagram illustrating a possible second configuration in use for a portion of a digital noise reduction block. Referring to FIG. 3, there is shown distribute blocks 302, 314 and 320, processing blocks 304, 306 and 328, pipeline delay blocks 312, 316, 318, 322 and 326, a merge_and_blend block 308, merge blocks 310 and 330, and a blend block 324. The distribute block 302, 314 or 320 may be similar to the distribute block 202 (FIG. 2). The processing block 304, 306 or 328 may be similar to the processing block 204, 208, or 216 (FIG. 2). The pipeline delay block 312, 316, 318, 322 or 326 may be similar to the pipeline delay block 206, 212, 214 or 218 (FIG. 2). The merge_and_blend block 308 may be similar to the merge_and_blend block 210 (FIG. 2).

The merge blocks 310 and 330 may comprise suitable logic, circuitry, and/or code that may be adapted to synchronize the ready and accept handshaking signals among three or more video handling blocks. The blend block 324 may comprise suitable logic, circuitry, and/or code that may be adapted to receive various inputs of video data and combine the received video data into one stream of video data. The ready-accept handshaking may be as described with respect to FIG. 2.

This illustration may be parallel processing of video data where the video data is processed and blended as soon as the processing is finished by a client. Video data may be received by the distribute block 302, and the distribute block 302 may communicate the video data to be processed to the pipeline delay block 316. The pipeline delay block 316 may communicate delayed video data to the processing block 304 and to the pipeline delay block 312 for further processing. The output signal of the processing bock 304 may be communicated to the processing block 306. The processed output data from the processing block 306 may be communicated to the merge_and_blend block 308.

The pipeline delay block 312 may communicate delayed video data to the distributive block 314. The distributive block 314 may communicate video data to the pipeline delay block 318. The pipeline delay block 318 may communicate its output to the distributive block 320 and to the processing block 328. The distributive block 320 may communicate its output to the pipeline delay block 322, which may communicate its output to the blend block 324. The processing block 328 may also communicate its output to the blend block 324, and the blend block 324 may have an output that is blended video signal of the two inputs communicated from the pipeline delay block 322 and the processing block 328. The output of the blend block 324 may be communicated to the processing block 306 and to the pipeline delay block 326. The output of the pipeline delay block 326 may also be communicated to the processing block 306, and to the merge_and_blend block 308. The output of the merge_and_blend block 308 may be the video data signal o_data.

The distribute block 302 may handshake with the processing block 304 and the pipeline delay block 316. The merge block 310 may synchronize the ready-accept signals among the processing block 304 and the pipeline delay blocks 312 and 316. The distributive blocks 314 and 320 may handshake with the processing block 306. The distributive block 314 may also handshake with the pipeline delay block 318. The pipeline delay block 318 may also handshake with the processing block 328. The distributive block 320 may also handshake with the pipeline delay block 322. The merge block 330 may synchronize the ready-accept signals among the blend block 324, the pipeline delay blocks 326, and the processing block 328. The processing block 306 and the pipeline delay block 326 may handshake with the merge_and_blend block 308. The various blocks may operate synchronously by utilizing a pre-determined clock signal or clock signals.

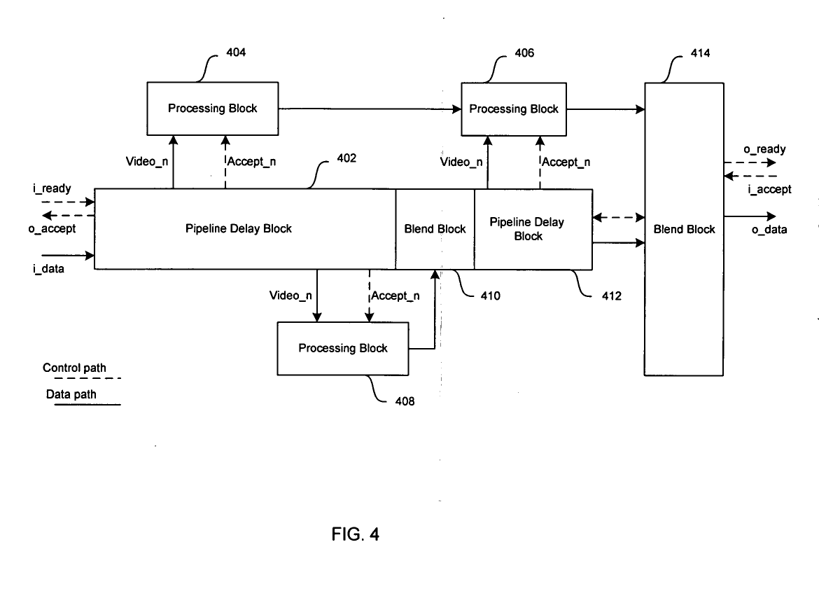

FIG. 4 is a block diagram illustrating an exemplary configuration in use for a portion of a digital noise reduction block with shared data buffer and synchronized control, in accordance with an embodiment of the invention. Referring to FIG. 4, there is shown pipeline delay blocks 402 and 412, processing blocks 404, 406, and 408, and blend blocks 410 and 414. The pipeline delay blocks 402 and 412 may comprise suitable logic, circuitry, and/or code that may be adapted to synchronously delay video data in order that the various video data may be correctly aligned with each other. The pipeline delay blocks 402 and 412 may be similar to the pixel buffer 106 or the chroma delay block 120 (FIG. 1).

The processing blocks 404, 406, and 408 may comprise suitable logic, circuitry, and/or code that may be adapted to process video data, and output the processed video data with appropriate delay in a synchronous manner. The processing block 404, 406, or 408 may be, for example, similar to the BV MNR block 114, the horizontal BNR block 108, or the vertical BNR block 110 (FIG. 1). The blend blocks 410 and 414 may comprise suitable logic, circuitry, and/or code that may be adapted to receive various inputs of video data and combine the various received video data into one stream of video data. For example, the blend block 408 may blend video data from the processing block 408 and from the pipeline delay block 402 to provide video data to the pipeline delay block 412. In this respect, the blend blocks 410 and 414 may be similar to the combiner 112 and/or VB transmitter 122 (FIG. 1). There is also shown an input ready signal i_ready, an output ready signal o_ready, an input accept signal i_accept, an output accept signal o_accept, an input data signal i_data, and an output data signal o_data. Furthermore, a plurality of pixel accept signals referred to as accept_n and a plurality of video signals referred to as video_n may be communicated to each of the processing blocks 404, 406, and 412, from the pipeline delay blocks 402 and 412.

The plurality of video signals video_n may comprise pixels of video data at different positions in the pipeline delay blocks. For example, the processing block 404 may process pixels at positions 5 and 13 in a horizontal line of video. In this regard, the pixels at positions 5 and 13 may comprise the video signals video_n. Similarly, the plurality of pixel accept signals accept_n may correlate to the pixels in the video signals video_n. If the video signals comprise pixels at positions 5 and 13, the plurality of pixel accept signals accept_n may correspond to the pixels at positions 5 and 13. When a pixel accept signal is asserted, the corresponding pixel may be accepted as a valid pixel.

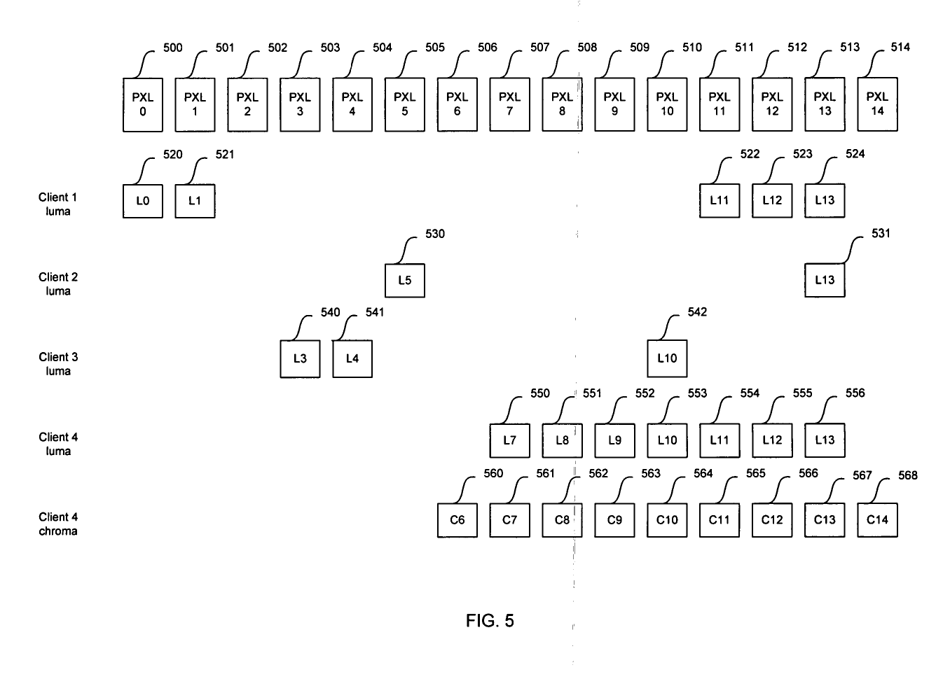

The various blocks may utilize ready-accept handshaking to transfer video data. The ready-accept handshaking may be similar to the ready-accept handshaking described with respect to FIG. 2. In this regard, the input ready signal i_ready and the output accept signal o_accept may be asserted and/or deasserted in order to control the flow of video data, via the input data signal i_data, into the pipeline delay block 402. The video data may be accepted by the pipeline delay block 402, and the video data may be shifted synchronously. The plurality of video signals video_n may be communicated to the processing blocks 404, 406, and 408. Additionally, the pixel accept signals accept_n may also be communicated to the processing blocks 404, 406, and 408. When the appropriate pixel accept signal is asserted, the processing block may accept the associated pixel. This will be explained further with respect to FIGS. 5-7.

In operation, the pipeline delay block 402 may accept data and shift the data synchronously. Appropriate accept signals may be asserted to the processing unit 404. The processing unit 404 may process the appropriate pixels and communicate the output to the processing unit 406. The pipeline delay block 402 may communicate the appropriate pixel accept signals to the processing block 408. The processing block 408 may process the pixels and communicate the output to the blend block 410. The blend block 410 may blend the video output of the processing block 408 with the video output communicated by the pipeline delay block 402. The resulting video output may be communicated to the pipeline delay block 412.

Appropriate pixel accept signals corresponding to the desired pixel positions in the pipeline delay block 412 may be communicated to the processing unit 406. The processing unit 406 may process the video and communicate the processed output to the blend block 414. The pipeline delay block 412 may utilize ready-accept handshaking to communicate its output to the blend block 414. The blend block 414 may blend the video data communicated by the processing block 406 and the pipeline delay block 412 to generate an output video signal o_data. The various blocks may operate synchronously by utilizing a pre-determined clock signal or clock signals.

FIG. 5 is a block diagram illustrating an exemplary multi-client mode usage model of a pixel buffer in a video noise reduction application, in accordance with an embodiment of the invention. Referring to FIG. 5, there is shown a plurality of pixel positions 500 . . . 514 for a horizontal line of video data. Video data may comprise two types of pixels—luma and chroma. A luma pixel may comprise brightness information and chroma may comprise color information. The Clients 1-4 are processing blocks that may require pixels as inputs to generate new pixel values. For example, the processing block 408 (FIG. 4) may be a processing block that generates a new value for the first pixel of a horizontal line by taking an average of multiple pixels. Client 1 may, for example, process various pixels to generate luma pixels 520, 521, 522, 523, and 524. Client 2 may process various pixels to generate luma pixels 530 and 531. Similarly, Client 3 may generate luma pixels 540, 541, and 542. Additionally, Client 4 may process various pixels to generate luma pixels 550-556 and chroma pixels 560-568.

The generated pixels may be blended with the corresponding original pixels in, for example, the pipeline delay blocks 402 or 412 (FIG. 4). Blending the generated pixels and the original pixels may, for example, utilize an algorithm that may take a weighted average of the pixels. The algorithm may be design and/or implementation dependent, and may range from using only the generated pixels to using some combination of the generated pixels and the original pixels to using only the original pixels. The blending may be performed by, for example, the blend block 410 or 414 (FIG. 4).

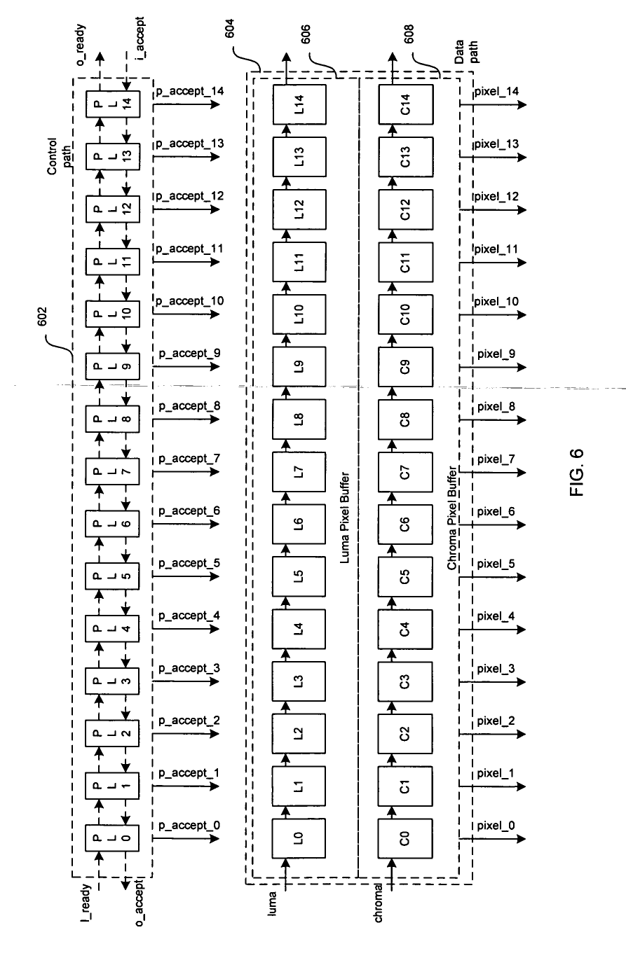

FIG. 6 is a block diagram illustrating an exemplary centralized reference control with common data buffer, in accordance with an embodiment of the invention. Referring to FIG. 6, there is shown a control pipeline 602 and a shared buffer 604. The control pipeline 602 may comprise a plurality of pipeline stages PL0 . . . PL14. Each of the pipeline stages PL0 . . . PL14 may comprise suitable logic, circuitry and/or code that may be adapted to control flow of data in the shared buffer 604. The shared buffer 604 may comprise a luma pixel buffer 606 and a chroma pixel buffer 608 where luma pixels L0 . . . L14 and chroma pixels C0 . . . C14, respectively, may be stored for the corresponding pipeline stages PL0 . . . PL14.

A present pipeline stage may communicate to a subsequent pipeline stage a ready signal that may be asserted to indicate that new data may be available for the subsequent pipeline stage. The subsequent pipeline stage may communicate to the present pipeline stage an accept signal that may be asserted to indicate that it has accepted the new data. In this manner, each of the pipeline stages PL0 . . . PL14 in the control pipeline 602 may communicate via the ready-accept handshaking signals with a previous pipeline stage and a subsequent pipeline stage to control the flow of data in the shared buffer 604. For example, the pipeline stage PL3 may communicate an asserted ready signal to the subsequent pipeline stage PL4 when it has accepted new data L3 and C3 in the luma pixel buffer 606 and the chroma pixel buffer 608, respectively, from the previous pipeline stage PL2. The subsequent pipeline stage PL4 may accept the data from the pipeline stage PL3 and may assert the accept signal to indicate to the present pipeline stage that the data has been accepted. Accordingly, a pipeline stage may accept new data when it is provided by the previous pipeline stage and when it is ready to accept the new data.

There is also shown a plurality of pixel accept signals p_accept_0 . . . p_accept_14 and a plurality of corresponding pixels pixel_0 . . . pixel_14. All, or a subset, of these pixel accept signals may be communicated to a processing block, for example, the processing block 408 (FIG. 4). The pixel accept signal, when asserted, may indicate to the processing block that the appropriate pixel may be accepted. The pixel accept signals at each pipeline stage, for example, the pixel accept signal p_accept_3 for the pipeline stage PL3, may be generated similarly as the accept signal for that stage. For example, the conditions that lead to assertion of the accept signal communicated to the pipeline stage PL2 may lead to assertion of the pixel accept signal p_accept_3.

Although only luma and chroma pixels may have been shown in this figure, the invention need not be so limited. For example, the data path may also include phase information for the video pixels.

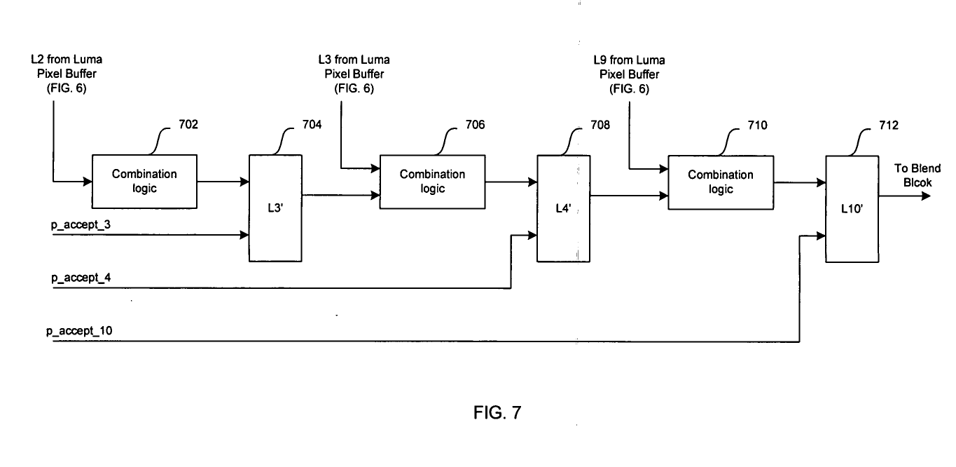

FIG. 7 is a block diagram illustrating an exemplary data path for client 3 in FIG. 5, in accordance with an embodiment of the invention. Referring to FIG. 7, there is shown pixel processing blocks 702, 706, and 710, and pixel storage blocks 704, 708, and 712. The pixel processing blocks 702, 706, and 710 may comprise suitable logic, circuitry and/or code that may be adapted to process pixels and generate a new pixel value. The pixel storage blocks 704, 708, and 712 may comprise suitable logic, circuitry and/or code that may be adapted to store the new pixel value. For example, each of the pixel storage blocks 704, 708, and 712 may be implemented using a register.

In operation, the pixel processing blocks may have as inputs specific pixels from the common data buffer shown in FIG. 6. For example, the input of the pixel processing block 702 may be the luma pixel L2 of the pipeline stage PL2. Similarly, the inputs of the pixel processing blocks 706 and 710 may be the luma pixels L3 and L9 of the pipeline stages PL3 and PL9, respectively. The pixel processing blocks may then process the received luma pixels. However, the outputs of the pixel processing blocks 702, 706, and 710 may change as the input luma pixels change as they are shifted through the common buffer, for example, the luma pixel buffer 606 (FIG. 6). When the appropriate pixel accept signal, for example, p_accept_3, is asserted, the output of the pixel processing block 702 may be stored by the pixel storage block 704. Similarly, the assertion of the pixel accept signals p_accept_4 and p_accept_10 may indicate that the outputs of the pixel processing blocks 706 and 710, respectively, may be stored in the pixel storage blocks 708 and 712, respectively.

In this manner, the pixel values stored in the pixel storage blocks 704, 708 and 712 may be synchronized with the appropriate pixels shifted in to the pipeline stages. Accordingly, a blend block, for example, the blend block 410 or 414 (FIG. 4), may then blend the generated pixels with the appropriate pixels in the pipeline delay block 402 or 412, respectively. A plurality of pixel accept signals, for example, p_accept_3, p_accept_4, and p_accept_10, may be generally referred to as accept_n. Similarly, a group of pixels, for example, luma pixels L2, L3, and L9, may be generally referred to as video_n. The various blocks may operate synchronously by utilizing a pre-determined clock signal or clock signals.

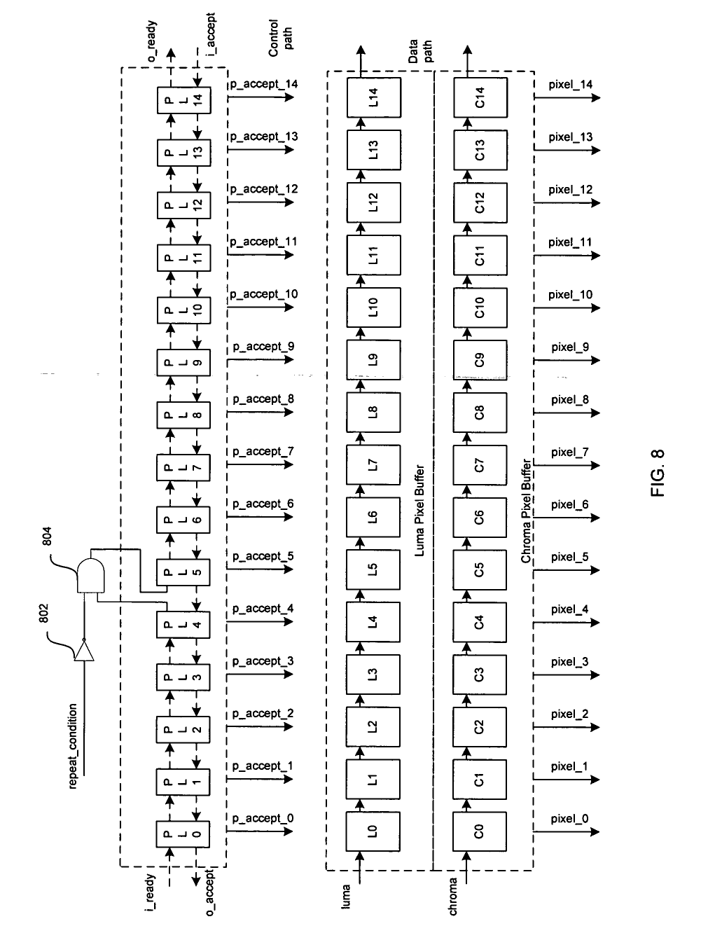

FIG. 8 is a block diagram illustrating an exemplary repeat data control for luma pixel L5 in FIG. 5, in accordance with an embodiment of the invention. FIG. 8 is similar to FIG. 6, however, the ready signal from pipeline stage PL 4 may be processed, for example, by combinational logic comprising components such as an inverter 802 and an AND gate 804. The output of this combinational logic may be the ready signal that is communicated to the pipeline stage PL5. In this manner, when a repeat condition signal (repeat_condition) is asserted, the ready signal input to the pipeline stage PL5 may be deasserted regardless of whether the ready signal from the pipeline stage PL4 is asserted or deasserted. Thus, the pipeline stage PL5 may be prevented from accepting new data from the pipeline stage PL4. Therefore, the data in the pipeline stage PL5 may be kept for a further period of time until the repeat condition signal (repeat_condition) is deasserted. When the repeat condition signal (repeat_condition) is deasserted, the state of the ready signal from the pipeline stage PL4 may be communicated to the pipeline stage PL5.

The repeat condition signal (repeat_condition) may be asserted, for example, at a boundary condition such as at a beginning of a video line or at the end of a video line. For example, a client such as the processing block 408 (FIG. 4), may replace the value of a pixel with an average of that pixel and the pixel immediately before and after it. However, at the start of a line, there may not be a pixel immediately before it. Therefore, the first pixel may be replicated in order to be able to generate an average value for the first pixel. Similarly, a last pixel on a line may have to be replicated since there may not be a pixel after the last pixel on the line. The repeat condition signal (repeat_condition) may be decoded from the input video stream since various information, such as line start and line end indications, may be included in the video stream. The repeat condition signal (repeat_condition) may be generated by suitable logic, circuitry and or code that may be adapted for such detection that may be, for example, in the VB receiver 102 (FIG. 1).

Although only luma and chroma pixels may have been shown in this figure, the invention need not be so limited. For example, the data path may also include phase information for the video pixels.

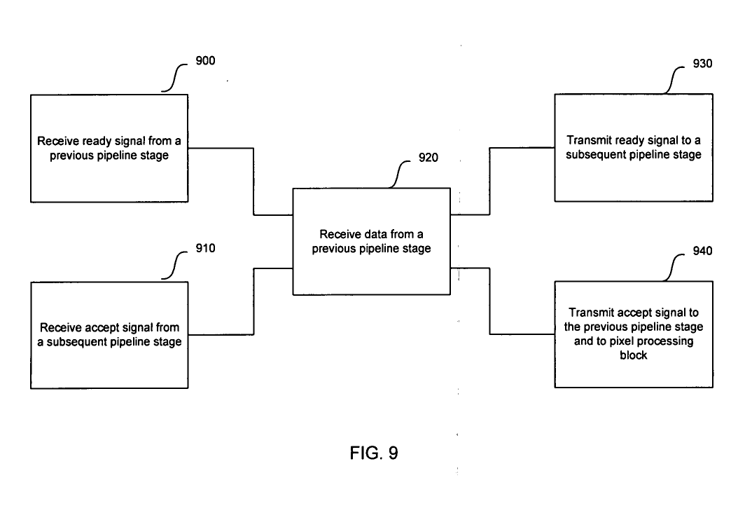

FIG. 9 illustrates an example flow diagram implementing a synchronized control scheme in parallel two-way handshaking system, in accordance with an embodiment of the invention. In step 900, a present pipeline stage may receive a ready signal from a previous pipeline stage. In step 910, the present pipeline stage may receive an accept signal from a subsequent pipeline stage. In step 920, the present pipeline stage may receive data from a previous pipeline stage. In step 930, the present pipeline stage may communicate a ready signal to a subsequent pipeline stage. In step 940, the present pipeline stage may communicate an accept signal to the previous pipeline stage and a pixel accept signal to a pixel processing block.

Referring to FIG. 9, there is shown a plurality of steps 900 to 940 that may be utilized to synchronously control data transfer. With reference to FIGS. 7-8, in step 900, a pipeline stage PL4 may receive an asserted ready signal from a pipeline stage PL3. In step 910, the pipeline stage PL4 may receive an asserted accept signal from a pipeline stage PL5. In step 920, the pipeline stage PL4 may then store the data from the pipeline stage PL3. In step 930, the pipeline stage PL4 may communicate a ready signal to the pipeline stage PL5. In step 940, the pipeline stage PL4 may communicate accept signals to the pipeline stage PL3 and to the pixel processing block, for example, the pixel processing block 704.

If, however, the repeat condition signal (repeat_condition) is asserted, although the ready signal from the pipeline stage PL4 may be asserted in step 930, the ready signal to the pipeline stage PL5 may be deasserted. This will effectively keep the pipeline stage PL5 from accepting new data. Furthermore, since the pipeline stage PL5 has not accepted data, it will not assert the accept signal to the pipeline stage PL4 in step 940. This may prevent pipeline stages previous to PL5 from accepting new data. In this manner, the same data may be kept for the pipeline stage PL5 as long as that data is required for processing at the PL5 pipeline stage. When normal pipeline shifting resumes, the repeat condition signal (repeat_condition) may be deasserted. This may allow PL5 to accept data, and allow assertion of accept signal to the pipeline stage PL4 in step 940.

When a subsequent pipeline stage, for example, the pipeline stage PL4, has accepted data from the present pipeline stage, for example, the pipeline stage PL3, the present pipeline stage PL3 may accept data from the previous pipeline stage, for example, the pipeline stage PL2, regardless of the accept signal input from the subsequent pipeline stage PL4. However, if the subsequent pipeline stage PL4 has not accepted data from the present pipeline stage PL3, then the present pipeline stage PL3 may not accept data from the previous pipelines stage PL2 until the subsequent pipeline stage PL4 indicates that it has accepted data from the present pipeline stage PL3 by asserting the accept signal to the present pipeline stage PL3. At times, this may mean that in order for the first pipeline stage PL0 to accept new data, each subsequent pipeline stage may have accepted data from an immediately previous pipeline stage.

Additionally, since the accept signal may be propagated from the highest position pipeline stage, for example, pipeline stage PL14, to the lowest position pipeline stage, for example, PL0, there may be a limit to the number of pipeline stages that may be cascaded for a given clock period. For example, if the number of pipeline stages in a pipeline delay block is limited to eight by a clock period, then the pipeline delay block illustrated in FIG. 8 may be separated to two pipeline delay blocks. In this regard, each pipeline delay block may have eight or fewer pipeline stages.

Usage of a shared buffer and a synchronized, central control mechanism, for example, in the pipeline delay block 402 and 412 (FIG. 4), may result in a simple and robust interface that may be easy to implement. As each client, for example, the processing block 404, 406, or 408 (FIG. 4), may receive synchronous control signals from the central control mechanism, it may be easier to ensure synchronous operation than if each client were to handshake for data transfer with its neighboring modules.

Although embodiments of the invention may have used video processing as an example, the invention need not be so limited. Embodiments of the invention may be used for other purposes, such as audio processing or digital signal processing, where data may be processed by a plurality of data processing blocks.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video data, the method comprising:
processing pixels by a plurality of data processing units using at least one shared buffer; and
communicating said pixels to said plurality of data processing units for said processing using a centralized and synchronized flow control mechanism.

2. The method according to claim 1, further comprising utilizing pixel accept signals to communicate said pixels from said at least one shared buffer to said plurality of data processing units without using a ready signal, wherein said pixel accept signals correspond to said pixels.

3. The method according to claim 2, further comprising generating said pixel accept signal based on an accept signal from a subsequent pipeline stage in said at least one shared buffer to a present pipeline stage in said at least one shared buffer.

4. The method according to claim 1, further comprising generating a control signal from said at least one shared buffer to at least one of said plurality of data processing units for centralized and synchronized data flow control.

5. The method according to claim 4, further comprising generating a delay that delays generation of said control signal.

6. The method according to claim 5, wherein said generated delay that delays generation of said control signal handles boundary conditions during processing.

7. The method according to claim 1, further comprising blending at least a portion of processed output pixel generated from at least a portion of said plurality of data processing units.

8. The method according to claim 1, further comprising pipelining the flow of said pixels between a plurality of pipeline stages within said at least one shared buffer.

9. The method according to claim 8, further comprising communicating an accept signal from a subsequent pipeline stage to a present pipeline stage for said pipelining.

10. The method according to claim 8, further comprising communicating a ready signal from a present pipeline stage to a subsequent pipeline stage for said pipelining.

11. A system for processing video data, the system comprising:
circuitry for processing pixels by a plurality of data processing units using at least one shared buffer; and
circuitry that communicates said pixels to said plurality of data processing units for said processing comprising a centralized and synchronized flow control mechanism.

12. The system according to claim 11, further comprising circuitry that utilizes pixel accept signals to communicate said pixels from said at least one shared buffer to said plurality of data processing units without using a ready signal, wherein said pixel accept signals correspond to said pixels.

13. The system according to claim 12, further comprising circuitry that generates said pixel accept signal based on an accept signal from a subsequent pipeline stage in said at least one shared buffer to a present pipeline stage in said at least one shared buffer.

14. The system according to claim 11, further comprising circuitry that generates a control signal from said at least one shared buffer to at least one of said plurality of data processing units for centralized and synchronized data flow control.

15. The system according to claim 14, further comprising circuitry that generates a delay that delays generation of said control signal.

16. The system according to claim 15, wherein said generated delay that delays generation of said control signal handles boundary conditions during processing.

17. The system according to claim 11, further comprising circuitry that blends at least a portion of processed output pixel generated from at least a portion of said plurality of data processing units.

18. The system according to claim 11, further comprising circuitry that pipelines the flow of said pixels between a plurality of pipeline stages within said at least one shared buffer.

19. The system according to claim 18, further comprising circuitry that communicates an accept signal from a subsequent pipeline stage to a present pipeline stage for said pipelining.

20. The system according to claim 18, further comprising circuitry that communicates a ready signal from a present pipeline stage to a subsequent pipeline stage for said pipelining.
